(19) United States
(12) Patent Application Publication
(10) Pub. No.: US 2005/0014053 A1
(43) Pub. Date: Jan. 20, 2005

(54) Fuel cell

(76) Inventors: Teruyuki Ohtani, Wako-shi (JP); Makoto Tsuji, Wako-shi (JP); Masao Utsunomiya, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/494,668

(22) PCT Filed: Oct. 23, 2002
(86) PCT No.: PCT/JP02/11008

(30) Foreign Application Priority Data
Dec. 27, 2001 (JP) 2001-396193

(51) Int. Cl. H01M 8/02; H01M 8/10

(52) U.S. Cl. 429/34; 429/30

(57) ABSTRACT

In a fuel cell comprising a laminate wherein a membrane electrode assembly is held by separators, the separator (20A) has a projection (21) contacting an membrane electrode assembly (10) with the contact angle between this projection (21) and the membrane electrode assembly (10) is set smaller than the contact angle of water with respect to the surface of the separator (20A). Regardless of the surface property of the separator, a corner part formed between the separator projection and membrane electrode assembly which contact with each other is so structured that water is unlikely to remain or penetrate. Thus, the draining capability of the gas channel is enhanced, improving power generating performance.

### TECHNICAL FIELD

The present invention relates to a fuel cell such as a solid polymer electrolyte fuel cell. In particular, the present invention relates to improvements in a separator which contacts a membrane electrode assembly of the fuel cell.

### BACKGROUND ART

In solid polymer electrolyte fuel cells, a separator is applied to both sides of a plate-shaped electrode (MEA: Membrane Electrode Assembly) to form a unit having a layered structure, and plural units are stacked to form a fuel cell stack. The MEA is a three-layered structure in which a polymerized electrolytic membrane, which is made of a resin such as an ion-exchange resin, is held by a pair of gas diffusion electrode plates (positive electrode plate and negative electrode plate). The gas diffusion electrode plate is composed of a gas diffusion layer formed outside of a catalytic layer which contacts with the polymerized electrolytic membrane. The separator is layered so as to contact with the gas diffusion electrode plate of the MEA, and gas passages and coolant passages where gas is circulated between the gas diffusion electrode plate and the separator are formed. According to the fuel cell, hydrogen gas as a fuel is provided to the gas passages facing the gas diffusion electrode plate at the negative electrode plate side, and an oxidizing gas such as oxygen or air is provided to the gas passages facing the gas diffusion electrode plate at the positive electrode plate side, and electricity is thereby generated by electrochemical reaction.

The separator must have characteristics that electrons generated by the catalytic reaction of the hydrogen gas at the negative electrode plate side are supplied to an external circuit, while electrons from the external circuit are supplied to the positive electrode plate side. Electrically conductive materials such as carbon-containing materials or metal-containing materials are used as the separator. The separators made of the carbon type materials are produced by molding or by cutting carbon-containing materials. The separators made of the metal-containing materials are produced by press forming of sheet metals such as stainless steel plates. In both cases, for example, the separators are formed with corrugations, and the gas passages and the coolant passages are composed of grooves formed on the surface and the reverse face thereof. Thus, the projections on the corrugated surface of the separator contact with the membrane electrode assembly (strictly speaking, the gas diffusion layer of the gas diffusion electrode plate).

When the above fuel cells generate electricity, water is generated in the gas passage of the electrode plate side, (in the above-described, the positive electrode plate side), in which an oxidizing gas flows, by reaction of oxygen with hydrogen ions. The water is generated in the interface between the projection of the separator and the diffusion electrode plate of the membrane electrode assembly. When the water accumulates in the gas passage, the water increases a diffusion over-voltage. In particular, the water lowers power generating performance of the fuel cell in generating electricity at high electrical current density. Therefore, the gas passage is preferably kept well-drained. For example, the drainage capability of the gas passage is increased by giving the surface of the separator a mirror-finish so as to be water-repellent.

Some metal separators are supposed to be composed of stainless steel plates having conductive inclusions in a metallographic structure thereof so that the conductive inclusions are utilized as conductive paths. Surface reforming processing for projecting the conductive inclusions on the surface is executed on the above separator so as to lower contact resistance between the separator and the membrane electrode assembly. In this case, since the surface of the separator is relatively rough, hydrophilicity thereof increases, and the contact angle of water with respect to the surface of the separator is small. As a result, water generated in the interface between the projection of the separator and the membrane electrode assembly easily accumulates in and infiltrates into a space therebetween, that is, a corner portion, whereby the drainage capability is inferior, and the above power generating performance decreases. Conventionally, the angle at the above corner portion, that is, the contact angle between the projection of the separator and the membrane electrode assembly, is about 90 degrees, and the contact angle of the water with respect to the surface of the separator is smaller than the angle at the above corner portion, whereby the water easily accumulates in and infiltrates into the corner portion.

### DISCLOSURE OF THE INVENTION

Therefore, an object of the present invention is to provide a fuel cell which prevents water from accumulating in and infiltrating into a corner portion formed between a projection of a separator and an membrane electrode assembly contacting with each other regardless of surface characteristics (hydrophilic or hydrophobic), enables increasing drainage capability of a gas passage, and thereby enables increasing power generating performance.

The present invention provides a fuel cell composed of a laminate comprising: separators having projections; and a membrane electrode assembly held by the separators, wherein the projections contact with the membrane electrode assembly with a contact angle which is smaller than a contact angle of water with respect to a surface of the separator.

The present invention can utilize a principle that, in a case in which a space is formed by a material in a shape of a wedge and a waterdrop infiltrates into the gap, the waterdrop cannot infiltrate into the inside thereof when an angle of the space is smaller than a contact angle of the waterdrop with respect to the material. According to the present invention, the contact angle between the projection of the separator and the membrane electrode assembly contacting with each other, that is, an angle at a corner portion (corresponding to the above space) formed therebetween is smaller than the contact angle of water with respect to the surface of the separator, whereby the water cannot infiltrate into the inside thereof. In a fuel cell, water is generated in the interface between the projection of the separator and the membrane electrode assembly, that is, in the innermost of the corner portion, the water is swiftly forced to leave therefrom. The water is continuously joined by water sequentially generated, whereby the total volume of the water gradually increases. Therefore, the water is forced out at the corner portion, thereby being removed therefrom.

FIG. 1A schematically shows a principle of the present invention. A corner portion is cut and chipped at an edge of a projection 21 of a separator 20A, whereby a contact angle between the projection 21 and a membrane electrode assembly 10 is set to be smaller than that of water with respect to the surface of the separator 20A. As the volume of water W generated in the interface between the membrane electrode assembly 10 and the separator 20A increases at a corner portion 30 formed therebetween, the water W is soon removed from the corner portion 30. On the other hand, FIG. 1B shows a projection 21 of a separator 20B and a membrane electrode assembly 10 in a conventional fuel cell to which the present invention is not applied, and the water W accumulates in a corner portion therebetween.

FIG. 2 is a schematic diagram showing a concept of a contact angle between a projection of a separator and a membrane electrode assembly. As shown in FIG. 2, when a fuel cell stack is composed by layering the separator 20 on the membrane electrode assembly 10, the projection 21 of the separator 20A is buried slightly in a diffusion electrode plate 10A of the membrane electrode assembly 10 by an assembling pressure. A contact angle θ of the projection 21 with respect to the membrane electrode assembly 10 is a crossing angle between the surface of the diffusion electrode plate 10A and a tangential line at a corner R of the projection 21 which crosses the surface of the diffusion electrode plate 10A. The contact angle θ is obtained as the following equation, assuming that A (%) is a compressibility of the membrane electrode assembly, B (mm) is an initial thickness before assembling the membrane electrode assembly, and R (mm) is a radius of the corner R of the separator:
cos θ=(R−0.01A×B×0.5)/R

The contact angle between the projection of the separator and the membrane electrode assembly is appropriately set depending on the contact angle of water with respect to the surface of the separator. In particular, it is effective that the contact angle therebetween be within 30 degrees in order to obtain the above effects reliably.

In addition, the separator of the present invention may be preferably made of metal such as a stainless steel and have conductive inclusions projected from the surface thereof. In the separator, the conductive inclusions may be projected from the surface thereof so as to reduce the contact resistance in the above manner. Due to this, the surface of the separator may be relatively rough, and the contact angle of water with respect to the surface thereof may be small. However, the contact angle between the projection and the membrane electrode assembly can be set to be smaller than that of water with respect to the surface, whereby both reduction of the contact resistance and good drainage can be obtained. As a result, the power generating performance can be improved remarkably.

For example, a stainless steel plate having the following components may be preferable to provide as the quality of the material of the above metal separator. That is, the stainless steel may comprise C: 0.15 wt. % or less, Si: 0.01 to 1.5 wt. %, Mn: 0.01 to 2.5 wt. %, P: 0.035 wt. % or less, S: 0.01 wt. % or less, Al: 0.001 to 0.2 wt. %, N: 0.3 wt. % or less, Cu: 0 to 3 wt. %, Ni: 7 to 50 wt. %, Cr: 17 to 30 wt. %, Mo: 0 to 7 wt. %, and balance of Fe, B and inevitable impurities, with contents of Cr, Mo, and B satisfying the following expression:
Cr (wt. %)+3×Mo (wt. %)−2.5×B (wt. %)≧17

According to the stainless steel plate, boron may be precipitated on the surface as M₂B type and MB type borides, and M₂₃ (C, B)₆ type boron carbide. These borides may be the conductive inclusions forming conductive paths on the surface of the separator.

### BRIEF DESCRIPTION OF DRAWINGS

FIG. 1A is a schematic diagram showing a principle of the present invention, and FIG. 1B is a schematic diagram showing conventional problems;

FIG. 2 is a cross sectional diagram showing a structure of the present invention;

FIG. 3 is a graph showing a relationship between a surface roughness of a separator produced in an example and a contact angle of a projection thereof according to the present invention;

FIG. 4 is a graph showing a relationship between a contact angle of a projection and a power generating voltage in respective separators of group A of the example:

FIG. 5 is a graph showing a relationship between a contact angle of a projection and a power generating voltage in respective separators of group B of the example;

FIG. 6 is a graph showing a relationship between a contact angle of a projection and a power generating voltage in respective separators of group C of the example;

FIG. 7 is a graph showing a relationship between a contact angle of a projection and a power generating voltage in respective separators of group D of the example; and

FIG. 8 is a graph showing a relationship between an electrical current density and a terminal voltage in fuel cell units which are composed of separators in which the contact angle of the projection is 30 degrees and in which the contact angle of the projection is 90 degrees out of those of group C of the example.

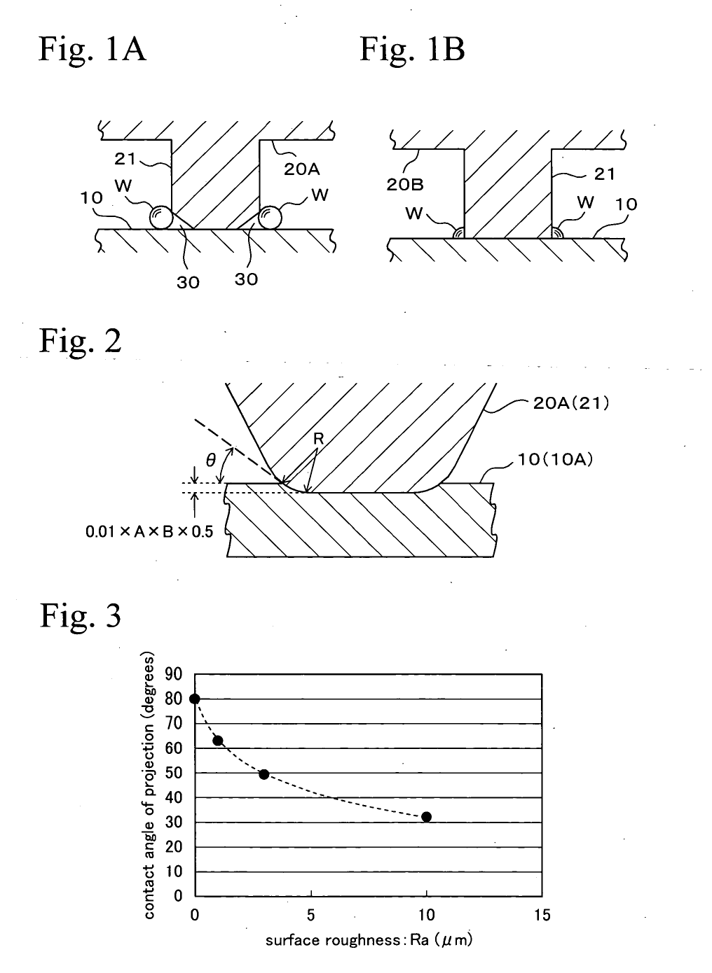

### BEST MODE FOR CARRYING OUT THE INVENTION

The present invention will be explained hereinafter with reference to a concrete example.

(1) Producing Separators

(A) Group A: First surface reforming processing method (contact angle of water: 63 degrees)

Austenitic stainless steel plates with the composition shown in Table 1, which were 0.2 mm thick, were formed into ten kinds of material plates of separators, which had different contact angles of a projection with respect to a membrane electrode assembly (that is, 15, 20, 30, 40, 45, 50, 60, 70, 80, and 90 degrees), by press forming. These material plates of separators were 92 mm×92 mm square and had a current collecting section having corrugations in the center thereof. Plural projections of the current collecting portion contact with the membrane electrode assembly. In the stainless steel plate, boron is precipitated in a metallographic structure thereof as M₂B type and MB type borides, and M₂₃ (C, B)₆ type boron carbide. These borides are conductive inclusions forming conductive paths. Next, the first surface reforming processing method was executed on the surface of these material plates of separators so as to project the conductive inclusions on the surface thereof, whereby separators of a group A were obtained. The first surface reforming processing method was a sand blasting method in which alumina grains having average grain sizes of 50 μm were used as abrasive grains. These abrasive grains were blasted on both sides of the material plates of separators at a pressure of 2 kg/cm². The blasting time was 20 seconds per side of the material plates of the separator. As a result, the contact angle of water with respect to the surface of the separator measured 63 degrees. In addition, the surface roughness (Ra) of the separator measured 1 μm.

TABLE 1

| C | Si | Mn | P | S | Cu | Ni | Cr | Mo | Al | N | B | Fe |
|---|---|---|---|---|---|---|---|---|---|---|---|---|
| 0.021 | 0.27 | 0.12 | 0.02 | 0.001 | 0.1 | 12.3 | 20.4 | 1.94 | 0.14 | 0.025 | 0.6 | Balance |

(B) Group B: Second surface reforming processing method (contact angle of water: 49 degrees)

Ten kinds of separators were obtained in the same manner as in the above group A except for using a second surface reforming processing method as a surface reforming processing method which was executed on the surface of material plates of separators. The second surface reforming processing method was a sand blasting method in which alumina grains having an average grain size of 180 μm were used as abrasive grains. These abrasive grains were blasted on both sides of the material plates of separators at a pressure of 2 kg/cm². The blasting time was 20 seconds per side of the material plates of the separator. As a result, the contact angle of water with respect to the surface of the separator measured 49 degrees. In addition, the surface roughness (Ra). of the separator measured 3 μm.

(C) Group C: Third surface reforming processing method (contact angle of water: 32 degrees)

Ten kinds of separators were obtained in the same manner as in the above group A except for using a third surface reforming processing method as a surface reforming processing method which was executed on the surface of material plates of separators. The third surface reforming processing method was a sand blasting method in which alumina grains having an average grain size of 600 μm were used as abrasive grains. These abrasive grains were blasted on both sides of the material plates of separators at a pressure of 2 kg/cm². The blasting time was 20 seconds per side of the material plates of the separator. As a result, the contact angle of water with respect to the surface of the separator measured 32 degrees. In addition, the surface roughness (Ra) of the separator measured 10 μm.

(D) Group D: Mirror finish method (contact angle of water: 80 degrees)

Ten kinds of separators were obtained in the same manner as in the above group A except for using a mirror finish method as a surface reforming processing method which was executed on the surface of material plates of separators. The mirror finish method was executed by an electrolytic polishing method under the following conditions, in which phosphoric acid type electrolytic polishing liquid (product of JASCO Co.: 6C 016) at 50° C. was used. The current density was 1 A/cm² and the electrolytic polishing time was 10 minutes. As a result, the contact angle of water with respect to the surface of the separator measured 80 degrees. In addition, the surface roughness (Ra) of the separator measured 0.2 μm.

The surface roughness (Ra) and the contact angle of water with respect to the surface of separators of the above groups A to D were studied under the following conditions. In measuring the surface roughness thereof, a tracer type surface roughness measuring device (product of MITUTOYO Co.: Surftest SJ201P) was used, and the measuring length was set to 2.5 mm. The contact angle of water with respect to the surface thereof was measured by a droplet method, in which droplets were adhered to solid samples and the solid samples were observed from the side thereof, using an image processing type contact angle measuring device (product of KYOUWA KAIMEN KAGAKU Co.: CA-X). FIG. 3 shows the relationship between the surface roughness (Ra) of the separators of groups A to D and the contact angle of water with respect to the surface thereof.

(2) Measuring Power Generating Voltage

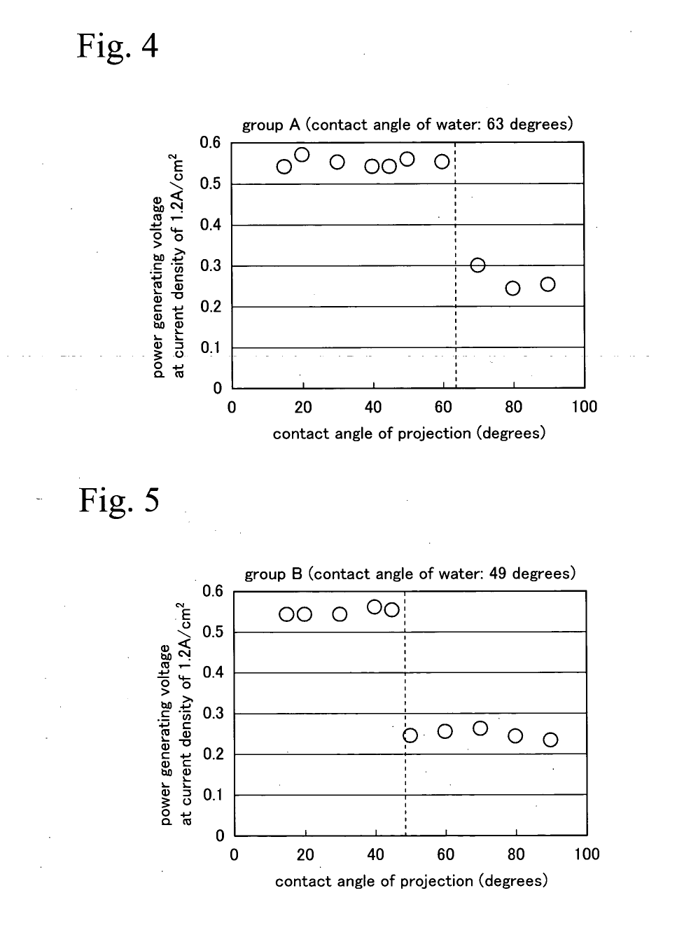

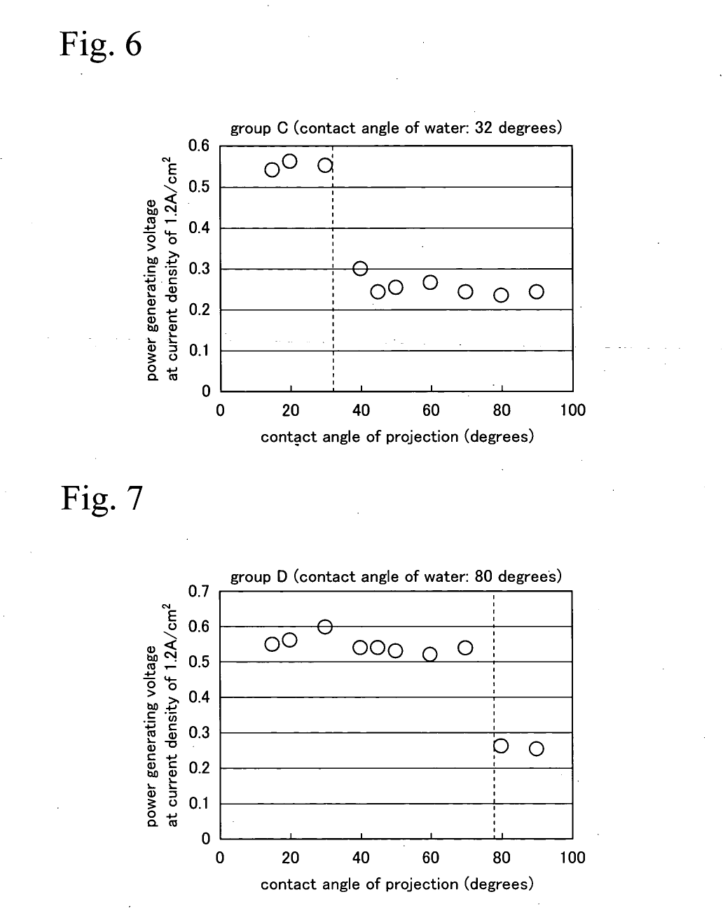

(a) Next, fuel cell units which were formed by layering separators on both sides of a membrane electrode assembly were produced for every separator of the above groups A to D. The above fuel cell units generated electricity, and power generating voltages thereof were measured at a current density of 1.2 A/cm², which was relatively high. FIGS. 4 to 7 are graphs of the above groups A to D in which relationships between the contact angle of the projection of the separator and power generating voltage are shown.

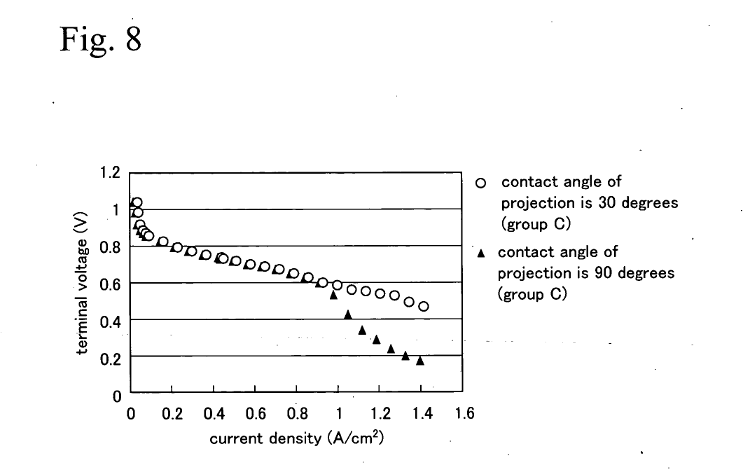

(b) Separators of which the contact angle of the projection was 30 degrees and 90 degrees were chosen out of the separators of the group C. Relationships between current density and terminal voltage of fuel cell units in which the above separators were used were measured. The measurement results are shown in FIG. 8. It is shown that the power generating performance was improved remarkably as shown in FIGS. 4 to 7 when the contact angle between the projection and the membrane electrode assembly was smaller than that of water with respect to the surface of the separator, whereby the effects of the present invention were demonstrated. In addition, the following, as shown in FIG. 8, was confirmed. That is, in a state in which current density exceeded 1.0 A/cm², the reduction of the terminal voltage was relatively prevented when the contact angle between the projection and the membrane electrode assembly was smaller than that of water with respect to the surface as in the present invention, although the terminal voltage was remarkably reduced in a state in which current density exceeded 1.0 A/cm² when the contact angle between the projection and the membrane electrode assembly was larger than that of water with respect to the surface as in the conventional method.

1. A fuel cell composed of a laminate comprising:
separators having projections; and
a membrane electrode assembly held by the separators,
wherein the projections contact with the membrane electrode assembly with a contact angle which is smaller than a contact angle of water with respect to a surface of the separator.

2. The fuel cell according to claim 1, wherein the contact angle between the projection and the membrane electrode assembly is within 30 degrees.

3. The fuel cell according to claim 1, wherein the separator is made of a metal, and conductive inclusions are projected from the surface of the separator.

4. The fuel cell according to claim 2, wherein the separator is made of a metal, and conductive inclusions are projected from the surface of the separator.
